(19) United States
(12) Patent Application Publication
(10) Pub. No.: US 2005/0210680 A1
(43) Pub. Date: Sep. 29, 2005

(54) Shaving appliance comprising at least one rotating flexible strip

(76) Inventor: Gernot Popp, Wien (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/513,601

(22) PCT Filed: May 5, 2003
(86) PCT No.: PCT/AT03/00130

§ 371 Date: Nov. 5, 2004

(30) Foreign Application Priority Data
May 7, 2002 (AT) A 709/2002

(51) Int. Cl. B26B 21/00

(52) U.S. Cl. 30/43.4; 30/32

(57) ABSTRACT

The invention relates to a shaving appliance comprising at least one rotating flexible strip (12) which is provided with a plurality of bezels, is guided in a guiding channel (3) in a cutting section (4), and is driven by a motor (10) in the longitudinal direction. The quality of one such shaving device is significantly improved by the fact that the guiding channel (3) is flexible in the cutting section (4).

The Invention relates to a shaving appliance comprising at least one rotating flexible band which is provided with a plurality of bezels, is guided in a guiding channel in a cutting section, and is further driven by a motor in the longitudinal direction.

Conventional appliances for electric shaving have rotating cutting blades or reciprocating blades. The disadvantageous aspect is the noise development and the limited number of applicable blades which limits the service life of the blade elements.

Shaving appliances have further become known which have a rotating flexible band which is driven by a motor. The band is guided in a guiding channel in a shaving section (i.e. the section which is guided along the skin when used properly). This guide channel is used for holding the band downwardly and in the lateral direction and to cover it towards the top at least in part, so that the blades of the band are exposed only in recesses of the top cover and any injury to the skin is prevented. Such solutions are described for example in U.S. Pat. No. 4,110,905 A, U.S. Pat. No. 3,381,374 A or U.S. Pat. No. 3,596,353 A.

Although a sufficient shortening of facial hair can be achieved with the known shaving apparatuses, the width of the region of optimal shaving is limited depending on the curvature of the skin in the respectively processed region and the time required for a proper shave is therefore long. Moreover, known shaving apparatuses quickly reach their performing capabilities where longer hair is encountered. A further disadvantage of conventional solutions is that there is a relatively high likelihood that hair stubble reaches the interior of the appliance and causes problems there. That is why frequent cleaning is required, which restricts the convenience in operating the appliance.

U.S. Pat. No. 4,110,905 A shows a shaving apparatus with an endless band comprising the required blades. The band is driven by a motor in the housing of the shaving apparatus and is guided via two deflection rollers between which a cutting section is disposed. The band is guided in a guide channel within the cutting section. The constructional unit consisting of the guide channel and the deflection rollers is resiliently held in the housing of the shaving apparatus. In this way it is possible to achieve a certain adjustment of the cutting section to the changing contour of the face. An adjustment to the curvature of the skin section to be processed is not possible with such a solution.

A further shaving apparatus is known from U.S. Pat. No. 3,596,353 A whose blades are arranged on an endlessly revolving band. In the cutting section provided between two deflection rollers, the band is held downwardly and supported by two resiliently held strips in order to ensure the required pretension jointly with the tensioning rollers. This solution also does not allow an adjustment to changing curvature conditions in the skin portion to be shaved.

Further shaving apparatuses of a similar kind are described in FR 1 591 279 A, U.S. Pat. No. 4,486,951A, U.S. Pat. No. 3,001,281 A and DE 11 74 652 B. The above statements apply in an analogous manner to said known shaving apparatuses.

It is the object of the present invention to avoid such disadvantages and to provide a shaving apparatus which allows a careful shave in a short period of time and comes with a simple configuration.

This object is achieved in accordance with the invention in such a way that the guide channel is flexible in the course of the cutting section. In this way, the band is allowed to adjust optimally to the respective curvature of the skin portion to be shaved in the region intended for shaving. As a result, the entire cutting section is generally in direct contact with the skin, thus achieving an overall optimal shave. The period for shaving can thus be reduced to a substantial extent.

The relevant aspect of the invention is that not only the cutting section and the guide channel are held in a movable or resilient manner in the housing, but that the guide channel is flexible, meaning that it can bend and thus can achieve an adjustment to the respective curvature of the skin.

It is preferably provided that the guide channel can be extended from an idle position to a working position. This helps to produce a compact overall size on the one hand. On the other hand, it is possible to achieve a large variability in the guide channel.

In a preferred embodiment of the invention it is provided that the guide channel is held on an elastic, preferably pneumatic element. An especially simple configuration can be achieved in this way. The pneumatic element can be pumped up by means of a small air pump for example which is driven by a motor. The pressure in the pneumatic element also allows setting the stiffness of the guide channel according to the respective requirements.

As an alternative it can be provided that the guide channel is preferably held in a resilient way on extensible supports. A robust and reliable apparatus can thus be realized.

It is especially favorable when a tensioning device is provided which tensions the band with a predetermined longitudinal force. An optimal shave is achieved through the even tension of the band.

An especially advantageous solution with respect to construction provides that the tensioning device controls the extension of the guide channel from the idle position to the working position and the retraction of the guide channel from the working position to the idle position. The tension of the guide channel can be solved simultaneously with the movement of the extension and retraction in a very simply way with respect to the design.

An especially compact solution is achieved when the tensioning device is made of deflection rollers which are displaceable substantially transversally to the longitudinal direction of the guide channel via a screw spindle. It is especially advantageous within the terms of simplification when the tensioning device is driven by the same motor as the band.

A malfunction due to excessive soiling can be securely prevented in such a way that the band is substantially completely encapsulated.

A favorable drive system can be realized when the band has a toothing which engages in a pinion driven by the motor.

The service life of the band can practically be doubled when the band has blades in both directions and can be driven in both directions.

An especially thorough shave is ensured when the band has blades both in the central region as well as at the edges.

An extensible long-hair trimmer can further be provided which is preferably driven by the same motor as the band. A simple design with an extended scope of functions can thus be achieved. In particular, a simplification can be achieved by using the same screw spindle as for the tensioning device.

The invention is now explained in closer detail by reference to embodiments shown in the drawings, wherein:

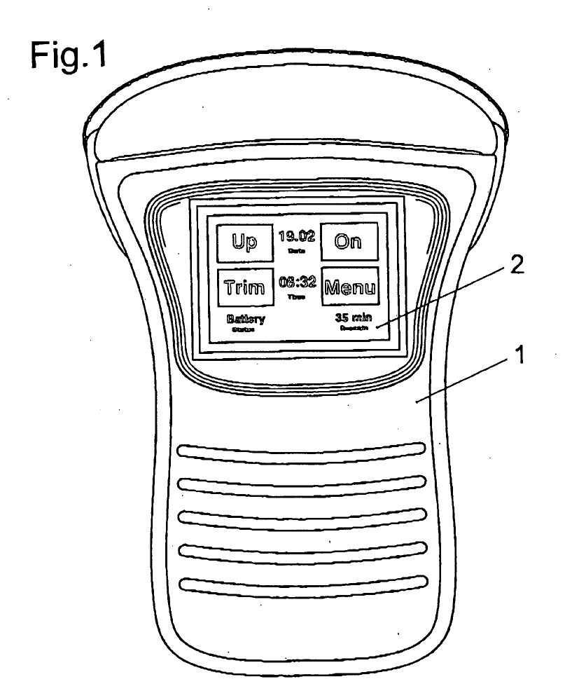

FIG. 1 shows a general view of a shaving apparatus in accordance with the invention;

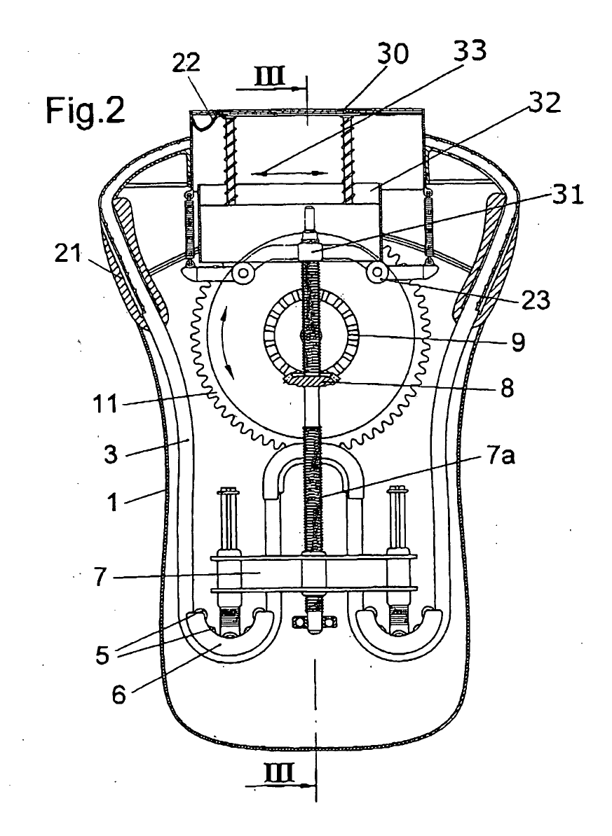

FIG. 2 shows a longitudinal sectional view through the appliance of FIG. 1;

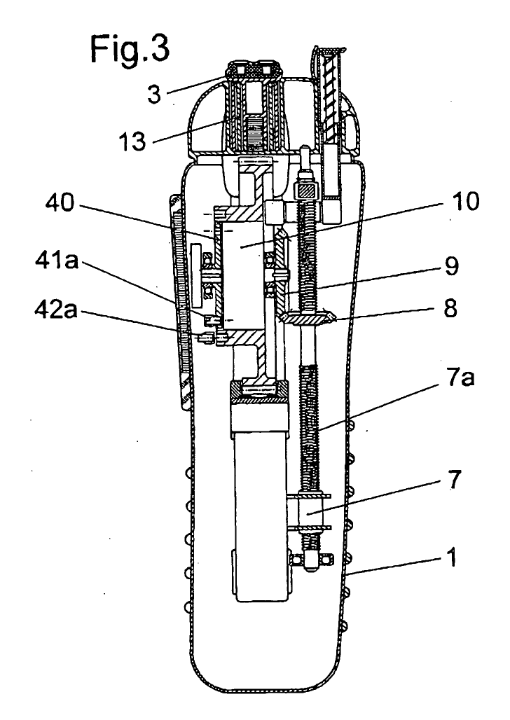

FIG. 3 shows a sectional view along line III-III in FIG. 2;

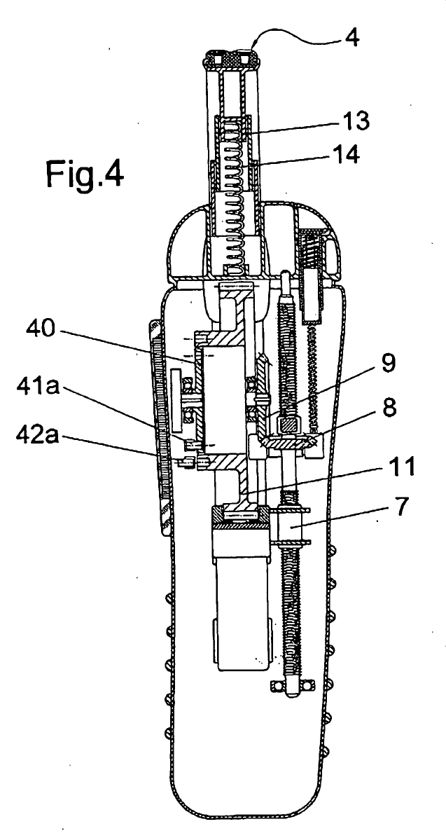

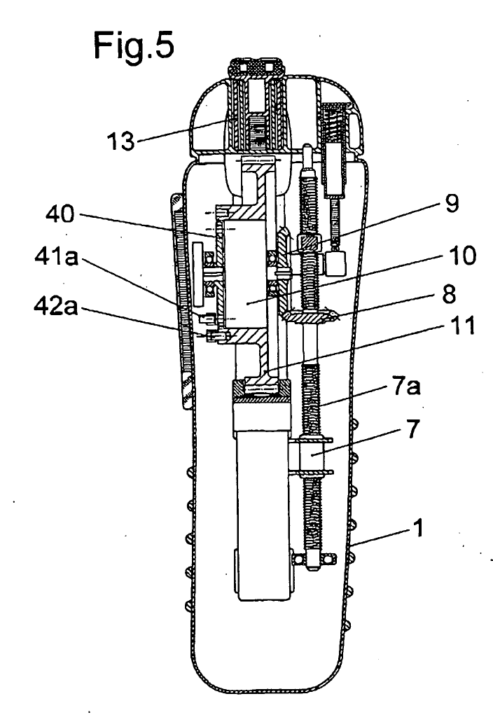

FIGS. 4 and 5 show sectional views according to FIG. 3 in other positions of the tensioning device;

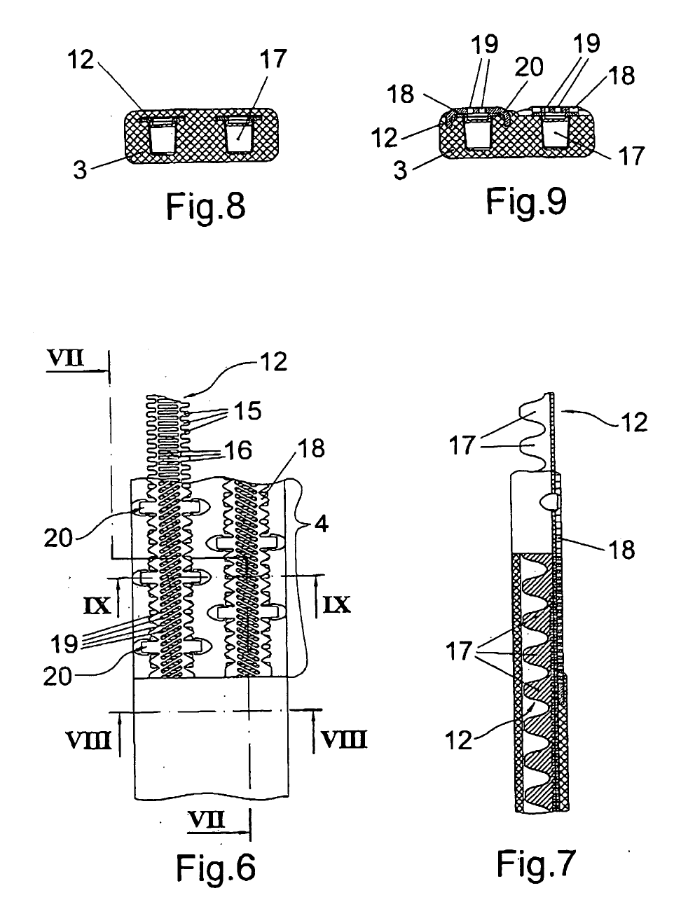

FIG. 6 shows a detail of the shaving apparatus;

FIG. 7 shows a sectional view along line VII-VII in FIG. 6;

FIG. 8 shows a sectional view along line VIII-VIII in FIG. 6;

FIG. 9 shows a sectional view along line IX-IX in FIG. 6;

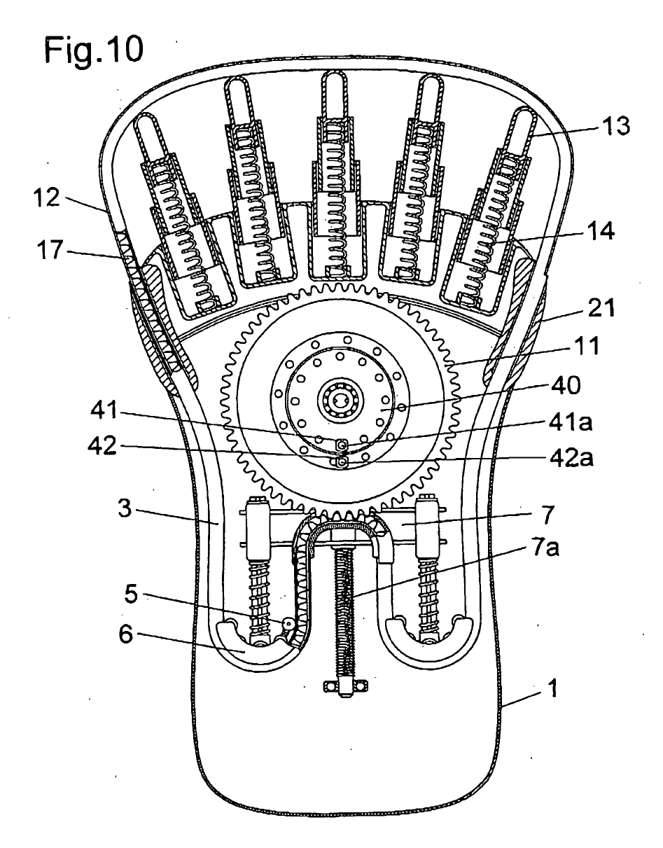

FIG. 10 shows a sectional view of the appliance with extended supports, and

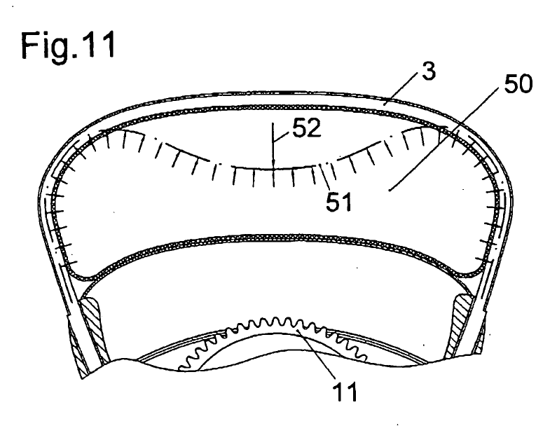

FIG. 11 shows a further embodiment of the invention in a sectional view.

The shaving apparatus in accordance with the invention consists of a housing 1 with a display and control panel 2.

A guide channel 3 is arranged in the interior of housing 1, which channel emerges from the same on the upper side of the housing in order to form the cutting section 4. The guide channel 3 is deflected about deflection rollers 5 in the interior of the housing 1, which rollers are held in fixing devices 6 and which fixing devices 6 are resiliently held by a bridge 7. The bridge 7 is held on a screw spindle 7a which is driven by a first angular wheel 8. The first angular wheel 8 is in engagement with a further angular wheel 9 which is driven by a motor 10. The motor 10 further drives a spur wheel 11 which is in engagement with two bands 12 arranged parallel with respect to each other and which are guided in the guide channel 3.

In the region of the cutting section 4, the guide channel 3 is supported by several telescopically extensible supports 13 which are each pretensioned by a compression spring 14 to the extended position.

Sealing elements 21 prevent the penetration of humidity, dirt or foreign particles into the interior of the housing 1.

In the position of FIG. 3, the bridge 7 is situated in the lowermost position and the deflection rollers 5 pull the guide channel 3 entirely to the bottom, so that the telescopically extensible supports 13 are fully retracted. FIG. 4 shows the extended position which is the working position for shaving at the same time. When the shaving apparatus is pressed against the skin, a number of the extensible supports 13 are pressed together depending on the exerted pressure force and optionally a number of other supports 13 are extended even further, with the tension of the guide channel 3 being substantially maintained.

A long-hair trimmer 30 is arranged in a vertically displaceable manner, with the drive being performed via a nut 31 which is in engagement with the same screw spindle 7a like the bridge 7. Merely the direction of the windings is different, so that the nut 31 always moves in the opposite direction relative to the bridge 7.

In the position of FIG. 2, the long-hair trimmer 30 is extended, with frictional wheels 23 for driving the long-hair trimmer resting on the inside of the spur wheel 11 and being driven by the same. A bar 32 is reciprocated within the terms of the double arrow 11 and drives a blade (not shown). A membrane 22 tightly seals the long-hair trimmer 30 in order to prevent the penetration of liquids or foreign particles.

FIGS. 4 and 5 schematically show the actuation of the individual functions. As a result of the electromagnetic extension or retraction of switching pins 41a and 42a in openings of a control disk 40 or the spur wheel 11, the motor 10 can be joined functionally either via the further angular wheel 9 with the screw spindle 7a or with the spur wheel 11.

In FIG. 5, the bridge 7 and the nut 31 of the long-hair trimmer 30 are arranged in a central position which corresponds to the idle position.

FIG. 6 shows a top view of a section of the guide channel 3, with the upper section in FIG. 6 corresponding to the cutting section 4, whereas the lower part represents the guide channel in the interior of the housing 1. Two bands 12 are arranged parallel with respect to each other in the guide channel 3, which bands are arranged outside of the cutting section 4 completely in the interior according to the recesses of the guide channel 3. The bands 12 comprise projections 15 at their two edges which are provided with rotating cutting edges, so that a cut can be performed irrespective of the direction of movement of the respective band 12. In the middle region the bands 12 comprise recesses 16 which are also limited on both sides by cutting edges. The bands 12 further comprise at their lower side a toothing 17 which is designated to be in engagement with the spur wheel 11.

In the region of the cutting section 4, the bands 12 are each covered by a cover plate 18 which comprises inclined openings 19 through which the hair to be cut can penetrate. Holding brackets 20 are used for anchoring the cover plates 18 on the guide channel 3. The holding brackets 20 of the cover plates 18 of the two bands 12 are mutually offset in order to ensure that all longer hair is gripped reliably.

FIG. 10 shows an alternative embodiment of the invention. In this embodiment, the guide channel 3 is held on a pneumatic element 50. The pneumatic element 50 can be filled permanently with gas such as air or can be brought to a working position by inflating from a vented idle position. When exerting a pressure force within the terms of arrow 52, the pneumatic element 50 can deform within the terms of the curve indicated with an unbroken line 51 and thus adjusted optimally to the respective skin contours.

1-16. (canceled)

17. A shaving appliance comprising at least one rotating flexible band which is provided with a plurality of blades, and which is guided in a guiding channel in a cutting section, and which is further driven by a motor in the longitudinal direction, wherein the guide channel is flexible in the course of the cutting section.

18. A shaving appliance according to claim 17, wherein the guide channel can be extended from an idle position to a working position.

19. A shaving appliance according to claim 17, wherein the guide channel is held on an elastic element.

20. A shaving appliance according to claim 17, wherein the guide channel is held on a pneumatic element.

21. A shaving appliance according to claim 17, wherein the guide channel is resiliently held on extensible supports.

22. A shaving appliance according to claim 17, wherein a tensioning device is provided which tensions the band with a predetermined longitudinal force.

23. A shaving appliance according to claim 22, wherein the tensioning device controls the extension of the guide channel from the idle position to the working position and the retraction of the guide channel from the working position to the idle position.

24. A shaving appliance according to claim 22, wherein the tensioning device is made of deflection rollers which are displaceable via screw spindle substantially transversally to the longitudinal direction of the guide channel.

25. A shaving appliance according to claim 22, wherein the tensioning device is driven by the same motor as the band.

26. A shaving appliance according to claim 17, wherein the band is substantially completely encapsulated.

27. A shaving appliance according to claim 17, wherein the band comprises a toothing which engages in a pinion driven by the motor.

28. A shaving appliance according to claim 17, wherein the band comprises blades in both directions and is drivable in both directions.

29. A shaving appliance according to claim 17, wherein the band comprises blades both in the central region as well as at the edges.

30. A shaving appliance according to claim 17, wherein two bands are provided adjacent to one another which are covered by cover plates.

31. A shaving appliance according to claim 30, wherein the cover plates are held by holding brackets which are mutually offset.

32. A shaving appliance according to claim 30, wherein the cover plates comprise inclined openings.

33. A shaving appliance according to claim 17, further including an extensible long-hair trimmer.

34. A shaving appliance according to claim 33, wherein said motor is connected to drive said extensible long-hair trimmer.
